(19) United States
(12) Patent Application Publication
(10) Pub. No.: US 2018/0115915 A1
(43) Pub. Date: Apr. 26, 2018

(54) DETERMINING NETWORK HEALTH BASED ON DATA FROM A USER DEVICE

(71) Applicant: Wandering WiFi LLC, Atlanta, GA (US)

(72) Inventors: Joseph Loeffler, Lilburn, GA (US); Dawei Cai, Atlanta, GA (US); Jyothiprakash Halebeed, Marietta, GA (US)

(21) Appl. No.: 15/792,113

(22) Filed: Oct. 24, 2017

Related U.S. Application Data
(60) Provisional application No. 62/411,824, filed on Oct. 24, 2016.

(51) Int. Cl. H04W 24/02; H04L 12/24

(52) U.S. Cl. CPC H04W 24/02; H04L 43/16; H04L 41/14

(57) ABSTRACT

Aspect are disclosed for determining network health based on data from a user device. A processing device can receive information about a network from a user device connected to the network. The processing device can also generate analytics about a health of the network based on the information. The processing device can also provide instructions identifying actions that can be performed to improve the health based on the analytics.

### CROSS REFERENCE TO RELATED APPLICATIONS

This disclosure claims the benefit of priority of U.S. provisional Application No. 62/411,824 titled “Systems and Methods for Monitoring Battery Life” and filed on Oct. 24, 2016, which is hereby incorporated in its entirety by this reference.

### TECHNICAL FIELD

This disclosure relates generally to computer-implemented methods and systems for connecting mobile devices to data networks and more particularly (although not necessarily exclusively), to determining network health based on data from a user device.

### BACKGROUND

User devices (e.g., mobile devices, such as smart phones and tablets) can connect to the internet or other data networks via wireless local area networks. For example, to connect to a wireless local area network, a mobile device connects to one or more access points using WiFi or other suitable wireless protocols. The mobile device activates WiFi in response to user input and searches for at least one service set identifier (“SSID”), which identifies an access point within a communication range of the mobile device. For instance, the mobile device can present a list of SSID's to a user and can receive user input selecting an SSID for a given WLAN. A mobile device can display a strength of the signal received from each access point to assist the user in selecting from the available SSID's. In some aspects, the strength of the signal received by the mobile device can be a poor indicator of the potential connection between the mobile device and the access point.

### SUMMARY

Aspects and examples are disclosed for systems and methods for monitoring the health of a data network and thereby facilitating reliable data communications via the data network. In some aspects, a system can receive information about a network from a user device connected to the network. The system can generate analytics about a health of the network based on the information. The system can provide instructions for performing actions to improve the health based on the analytics.

This illustrative example is mentioned not to limit or define the inventions, but to aid understanding thereof. Other aspects, advantages, and features of the present invention will become apparent after review of the entire description and figures.

### BRIEF DESCRIPTION OF THE DRAWINGS

Many aspects of the present disclosure can be better understood with reference to the following diagrams. The drawings are not necessarily to scale, with emphasis instead being placed upon clearly illustrating certain features of the disclosure.

FIG. 1 is a block diagram of an example of multiple data networks and a system for determining the health of the data networks based on data from user devices according to one aspect of the present disclosure.

FIG. 2 is a flow chart of an example of a process for determining network health based on data from a user device according to one aspect of the present disclosure.

FIG. 3 is a diagram of a user interface for a system for determining network health based on data from a user device according to one aspect of the present disclosure.

FIG. 4 is a diagram of a user interface for a system for determining network health based on data from a user device according to one aspect of the present disclosure.

FIG. 5 is a diagram of a user interface for a system for determining network health based on data from a user device according to one aspect of the present disclosure.

FIG. 6 is a diagram of a user interface for a system for determining network health based on data from a user device according to one aspect of the present disclosure.

FIG. 7 is a diagram of a user interface for a system for determining network health based on data from a user device according to one aspect of the present disclosure.

FIG. 8 is a block diagram of an example of devices in a system for determining network health based on data from a user device according to one aspect of the present disclosure.

### DETAILED DESCRIPTION

Computer-implemented systems and methods are disclosed for determining network health based on data from mobile devices or other user devices. Each user device can measure data about the user device's connection with a network. Data from the user device can be combined with data from other user devices that are (or have been) connected to the network. The combined data can be analyzed to determine a health of the network. Problems in the network can be identified, and instructions can be provided to the network operator or an access point for improving the network health. Instructions can be provided to the user device for improving the connection between the user device and the network. Determining the network health based on data from a user device can provide a more accurate representation of the quality of the network and allow for quicker detection and resolution of problems.

In some aspects, systems and methods disclosed herein can improve the accuracy of determining network health and improve an ability to detect and solve problems with the network. For example, some existing systems for determining network health can allow a user to submit a problem report by selecting a problem category (e.g., network speed) and optionally including a brief description. The problems experienced by an end-user device can be difficult to quantify using such a reporting system. Furthermore, the network environment can change (e.g., decrease in load) by the time that a network operator receives or reviews a complaint from an end-user device. The lack of quantitative information about a problem can make it difficult to accurately access network health and difficult to determine ways to improve the network health. But, as disclosed herein, storing and analyzing combined data from multiple user devices over a time period can allow the network conditions that resulted in a reported problem to be more effectively identified and remedied.

As used herein, the term “mobile device” can include a computing device capable of establishing wireless connections at multiple geographic locations. Examples of a mobile device include (but are not limited to) a laptop, mobile device, mobile computing device, tablet, Internet-of-things device.

As used herein, the term “authorized” can refer to a user having permission to use a device based on the user's identity, subscription, or other terms or conditions imposed upon the use of the mobile device. In some aspects, software can be executed locally on a device to authenticate a user or otherwise determine that a user is authorized to use the device. In additional or alternative aspects, a device can transmit credentials (e.g., a user name and password or some other identification data), which can be received from a user, to a remote server that executes the software for authenticating or otherwise determining that the user is authorized to use the device.

As used herein, the term “connect” can include establishing a communication channel between a mobile device and a WLAN via which the mobile device can access other network devices or other data networks via the WLAN. A connection to a WLAN can be established via any suitable wired or wireless method. A connection to a WLAN uses any suitable protocol, such as (but not limited to) Wi-Fi.

The foregoing illustrative examples are given to introduce the general subject matter discussed herein and are not intended to limit the scope of the disclosed concepts. The following sections describe various additional aspects and examples with reference to the drawings in which like numerals indicate like elements. The features discussed herein are not limited to any particular hardware architecture and/or configuration. A computing device can include any suitable arrangement of components that provide a result conditioned on at least one input. Suitable computing devices include multipurpose microprocessor-based computer systems accessing stored software that programs and/or configures the computing system from a general-purpose computing apparatus to a specialized computing apparatus implementing one or more aspects of the present subject matter. Any suitable programming, scripting, and/or other type of language and/or combinations of languages may be used to implement the teachings contained herein in software to be used in programming and/or configuring a computing device. Aspects and features from each embodiment disclosed can be combined with any other embodiment.

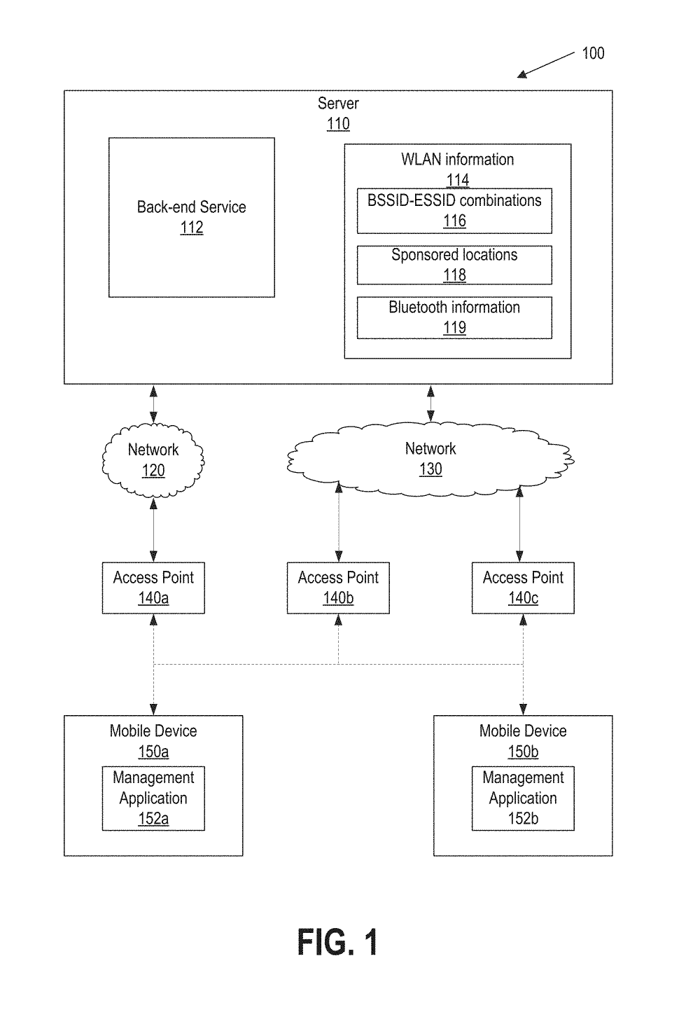

Turning now to the drawings, FIG. 1 is a block diagram depicting an example of a system 100 for determining network health based on data from a user device. The system can include a server 110 and mobile devices 150a-b. The mobile devices 150a-b can be connected to an access point 140a-c that can allow access to a network 120, 130 for connecting each mobile device 150a-b to the server 110. The mobile devices 150a-b can include a management application 152a-b that can communicate with a back-end service 112, which is executed by the server 110. For example, the management application 152a can configure the mobile device 150a to communicate with the server 110 via a WAN and/or via the access point 140a, which is connected to a data network 120. (Although FIG. 1 depicts the system 100 having mobile user devices 150a-b, a system can determine network health for stationary user devices connecting to a wireless network.)

In some aspects, network health can appear to be better from a perspective of an access point than actually experienced by one of the end-user device (e.g., one of the mobile devices 150a-b). For example, one of the access point 140a-c can be transmitting signals over a greater distance than one of the user devices 150a-b can transmit a signal. The user device 150a-b can detect the access point 140a-c by receiving the signals but be unable to connect to the access point 140a-c. From the perspective of the access point 140a-c, nothing may appear to be wrong with the network 120, 130. But, from the perspective of the user device 150a-b, the network 120, 130 may provide limited connectivity or present other connectivity issues. The system 100 can allow the user device 150a-b to transmit data about the network 120, 130 via different channels (e.g., a cellular network, an alternative data network provided by other access points, etc.). The system can determine that the user is too far from the access point 140a-c and provide instructions to the user device 150a-b to move closer. In some aspects, the network 120, 130 can be any wireless network. Examples of wireless networks include Wi-Fi networks, cellular networks (e.g., LTE or 4G), or short-range wireless networks (e.g., Bluetooth or ZigBee). The user device 150a-b can transmit the data over any other channel or through a different access point.

The management application 152a-b can operate in the background on the mobile device 150a-b. The management application 152a-b can record data about networks 120, 130 encountered by the mobile device 150a-b. In some aspects, the data can identify information such as (but not limited to) one or more of the access point 140a-c the user device is using to connect to the network 120, 130, the response time observed by the user device 150a-b, a location of the user device 150a-b, information about the access points 140a-c detected by the user device 150a-b, etc.

In some aspects, the management application 152a-b can determine which access point SSIDs have been encountered by the mobile device 150a-b (e.g., SSIDs that are broadcast or transmitted by access points 140a-c within communication range of the mobile device 150a-b). For a given WLAN, the SSID information can identify both an Extended Service Set Identification (“ESSID”), which is a human-readable component specific to the WLAN, e.g. “Free Wifi Network,” and a Basic Service Set Identification (“BSSID”), which is a unique hardware identifier for a specific access point 140a-c.

The back-end service 112 can maintain a database or other data store in which WLAN access point information 114 is stored. This WLAN access point information 114 can include multiple ESSID-BSSID combinations 116 for different WLAN access points 140a-c. This WLAN access point information 114 can also include associations between certain sponsored locations 118 (e.g., stores or other service-provider locations). In some embodiments, the back-end service 112 can also maintain a list of Bluetooth information 119 associated with the sponsored locations 118.

In some aspects, the management application 152a-b can record information about the access point 140a-c that the user device 150a-b is using to connect to a network 120, 130 and the response time observed by the user device 150a-b. In additional or alternative aspects, the data can include a location of the user device 150a-b and information about the access points 140a-c detected by the user device 150a-b. In some aspects, the data can be recorded in real time using a management application 152a-b and transmitted to the server 110 for organizing data about the network 120, 130. The recorded data can include a time-stamp provided by the user device 150a-b or a time stamp provided by the server 110 upon receipt of the data. The time stamp can allow the system 100 to retrieve data from a block of time related to the time of a problem that is reported by a user device 150a-b (e.g., the ten minutes before the problem was reported).

In some aspects, the data can be transmitted by the user device 150a-b in real-time (e.g., contemporaneously with the data being recorded). In other aspects, rather than transmitting the data to the server 110 in real time, the user device 150a-b can transmit the data in packets at predetermined intervals or in response to being on WiFi or a particular network 120, 130. In additional or alternative aspects, the user device 150a-b can maintain data for a predetermined length of time and transmit the data to the server 110 along with a problem report in response to detecting a problem.

In some aspects, the system 100 can use data received from multiple user devices 150a-b to determine a connectivity problem with a network 120, 130. For example, the system 100 can determine that the problem relates to a service provider associated with a network 120, 130 by comparing data received from user devices 150a-b connected to the same network 120, 130 using different access points 140a-c and user devices 150a-b connected to other networks 120, 130.

In some aspects, the system 100 can monitor the data and detect a problem in response to a difference between the data being received from a user device 150a-b and the average data received about a network 120, 130 being greater than a threshold value. The system 100 can provide instructions for improving the network health based on an analysis of the data. For example, the system 100 can suggest an increase in power level or movement of an access point 140a-c to reach addition devices. If a mobile device 150a-b consistently loses connection with a network 120, 130 servicing a certain geographical area when the mobile device 150a-b is positioned at specific locations in the geographical area (e.g., a store, a warehouse, a parking lot, or other commercial or residential structures), the mobile device 150a-b can provide data about its connectivity to the system 100.

In some aspects, the data can be used to improve network and data security by detecting fake access points. The system 100 can compare data about access points 140a-c received from user devices 150a-b. The system 100 can analyze the data and alert a user device 150a-b if data about an access point 140a-c is inconsistent with data received from other user devices 150a-b about the access point 140a-c.

In some aspects, the system 100 can analyze trends in network health based on various analytics generated using data received from user devices 150a-b. The system can identify or determine a baseline network health using one or more of the analytics. The system 100 can subsequently identify or determine trends in additional analytics generated from additional data received from use devices 150a-b. If the trends indicate a decrease in network health or other issue impacting the experience of user devices 150a-b on the network 120, 130, the system 100 can generate a notification regarding the trend. The notification can be transmitted from the system 100 to one or more computing devices associated with operators or administrators of the network 120, 130. In some aspects, the notification can include suggestions about corrective actions that may be taken to restore the network 120, 130 to a baseline health (e.g., adjusting the placement of access points, adjusting the output power of access points 140a-c, etc.).

In some aspects, the system 100 can monitor the data to determine types of user devices 150a-b that have a better experience on the network 120, 130. For example, some user devices 150a-b include better antennas or improved communication software. The system 100 can detect the user devices 150a-b having the best experience on the network 120, 130 and provide the data for product selection by consumers.

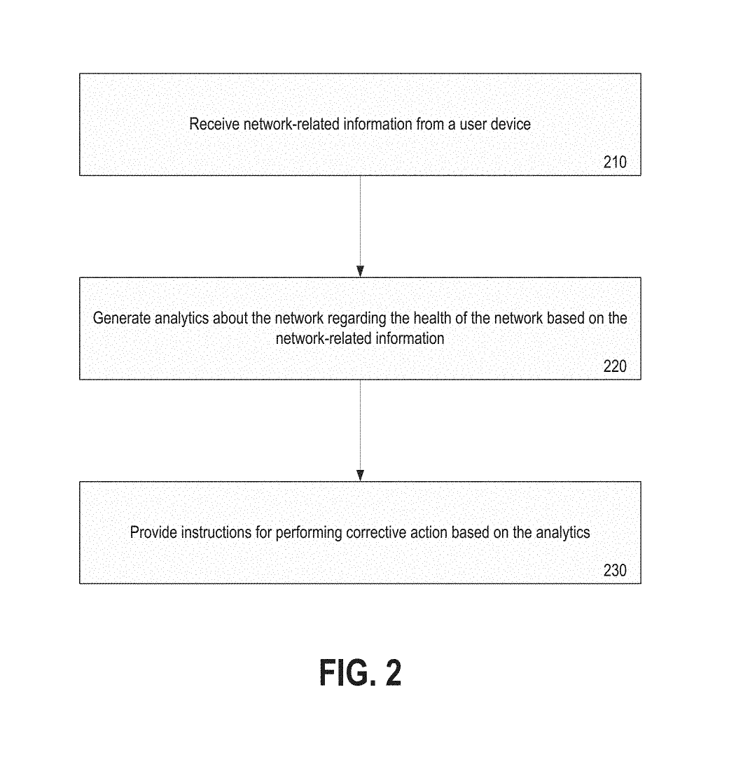

FIG. 2 is a flow chart of an example of a process for determining network health based on data from a user device. In some aspects, determining network health based on data from a user device can provide a more accurate representation of a network than determining network health based on data from an access point.

In block 210, the process can include receiving network-related information from a user device. In some aspects, a server can receive a stream of data from a management application that is executed on the user device. The management application can capture and transmit information to the server in real time. The management application can be configured to store packets of information and transmit the information at predetermined intervals or in response to the user device connecting to a particular type of network (e.g., WiFi). In some aspects, the data can include information based on the location of the user device. The location of the user device can be determined using one or more methods or criteria. Examples of these methods or criteria include (but are not limited to) triangulation of cellular signals, GPS, proximity to a wireless receiver, user input, or recognition of a landmark (e.g., scanning a barcode having a known location). In additional or alternative aspects, the data can include a number of detected access points and information identifying the access points. In additional or alternative aspects, the data can include information about the quality of the connection between the user device and an access point (e.g., response times or acknowledgment rates).

In block 220, the process can further include generating analytics about the network regarding the health of the network based on the network related information. In some aspects, analytics can be generated based on data from a single user device and can be used to determine actions for improving the experience of the user device. In additional or alternative aspects, the analytics can be generated based on a combination of multiple user devices over a time. Average response rates for a network can be determined and can be displayed at different scales (e.g., the network health in a single store or network health for a region).

In block 230, the process can further include providing instructions for performing corrective action based on the analytics. In some aspects, instructions can be provided for improving a current experience of a single user (e.g., temporarily turning up the power for an access point or instructing the user device to move closer to an access point). In additional or alternative aspects, instructions can be provided for improving network coverage. The instructions can be organic such that the system can analyze how the changes affect the network and modify the instructions to further improve the network health.

For example, in response to receiving data from the mobile device, the system can instruct a given access point to increase the power, provide suggestions about relocating the access point, or indicate another access point may be needed to cover a certain geographical area (e.g., a home or commercial building). In some aspects, the system can suggest decreasing the power level of an access point, turning off a channel at an access point to reduce channel interference, or deactivating a certain access point altogether to reduce interference in a given geographical area. In additional or alternative aspects, the system can monitor user devices and suggest placement of additional access points. For example, the system can monitor mobile devices and detect the number of mobile device that enter a geographic area with poor cell service and suggest a cell tower be built to improve service.

In some aspects, the corrective actions may include communicating suggestions to user devices. For example, if the system is capable of identifying multiple wireless networks servicing a certain geographic area, where the wireless networks are controlled by independent operators, the system can notify the user device to connect to one of the wireless networks that is likely to provide the best connectivity for the user device. In another example, the system can notify the user device to connect to a certain access point out of multiple access points in a given wireless network so that connectivity is improved for the user device. In another example, the system can notify a certain access point to hand off a user device to another access point in a given wireless network so that connectivity is improved for the user device.

In some aspects, the corrective actions can be proactively executed or suggested based on identifying certain device types in a geographical area. For example, a first network configuration may provide optimal coverage if the majority of user devices are portable scanners with wireless capability, a second network configuration may provide optimal coverage if the majority of user devices are smart phones, and other network configurations may provide optimal coverage for different mixes of smart phones and scanners in the area. The system can identify the device types in a given area to determine the mix of smart phones and scanners. The system can output data that may be used to configure the network in an optimal configuration for the mix of smart phones and scanners. The outputted data can be one or more suggestions provided to a network administrator or network control device, one or more commands transmitted to one or more network control devices, one or more commands transmitted to one or more access points, routers, or other network equipment, or some combination thereof. A certain configuration can include a certain combination of access points being activated, certain power levels being used by certain access points, certain frequency channels being used by certain access points, or any other configuration parameters for access points or other network equipment that control the wireless coverage provided by the network equipment in a geographic area.

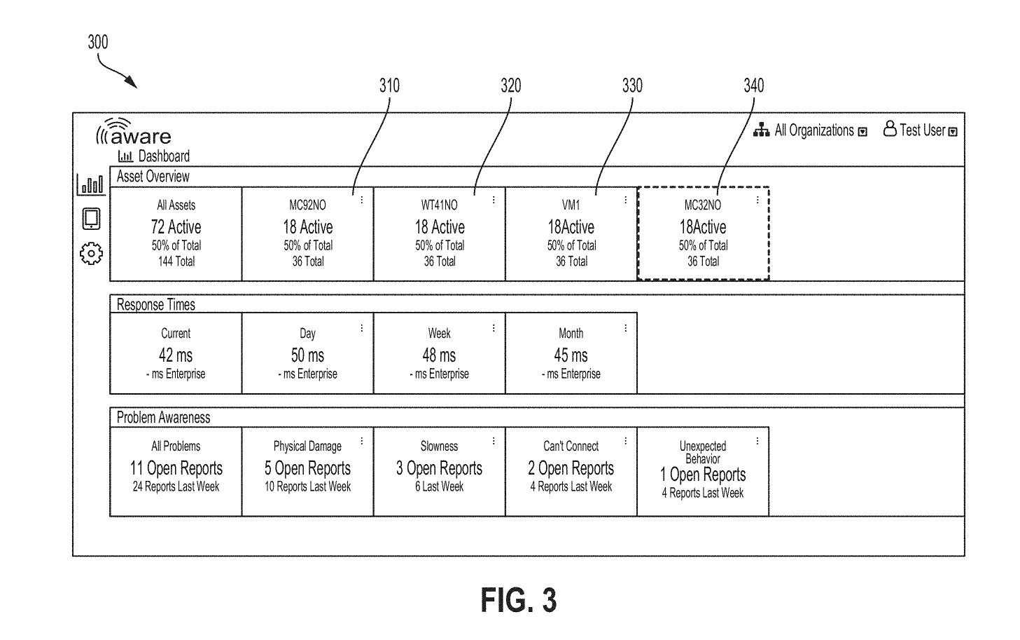

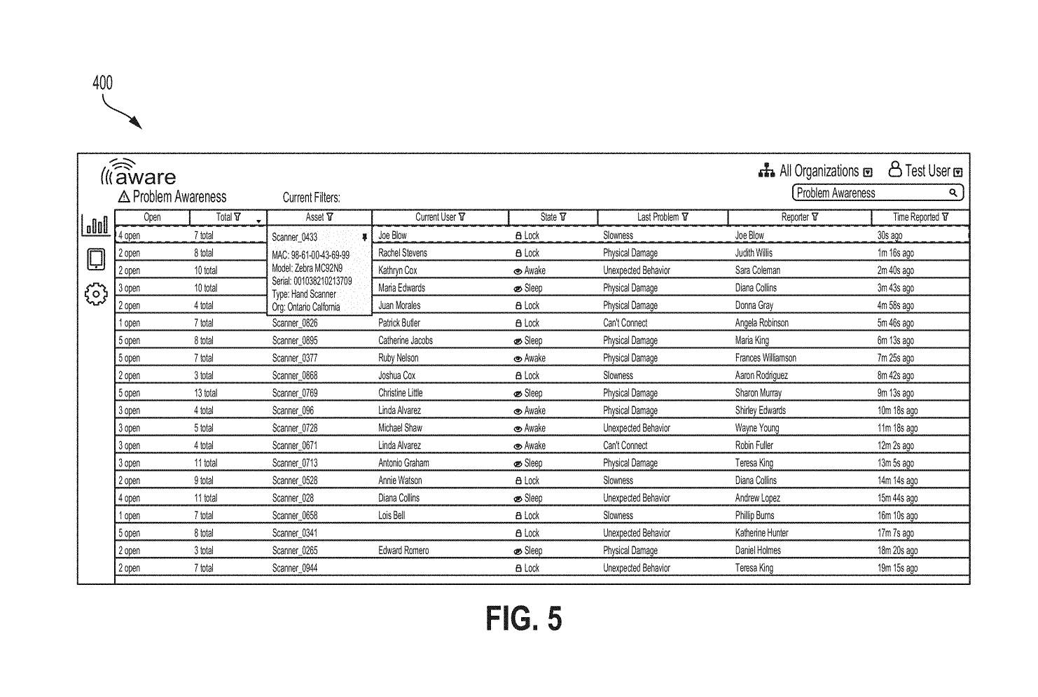

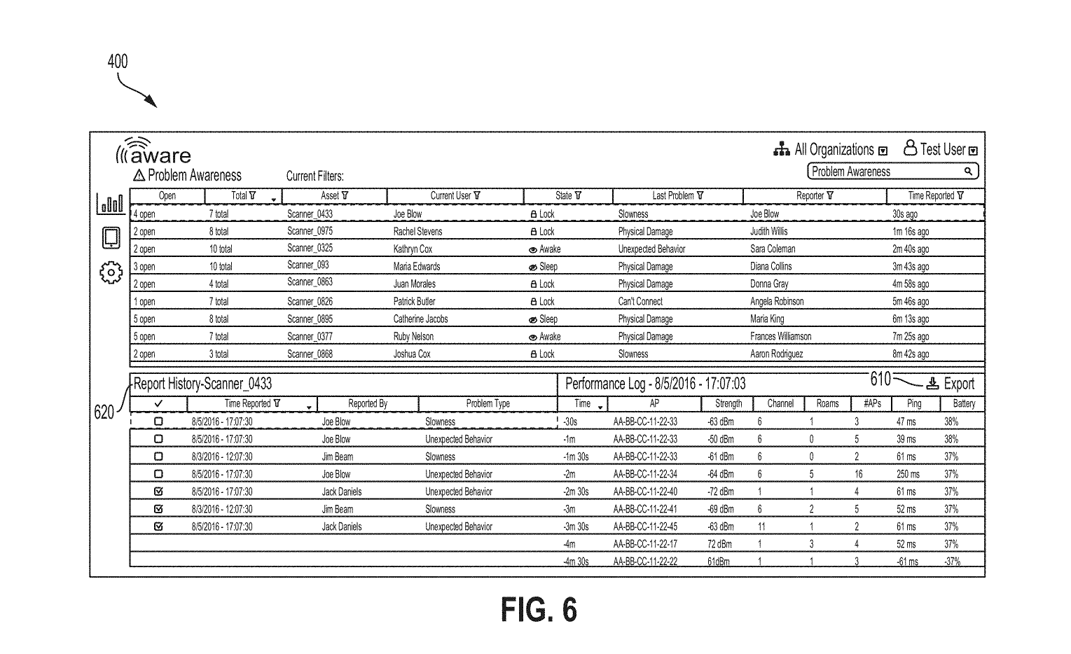

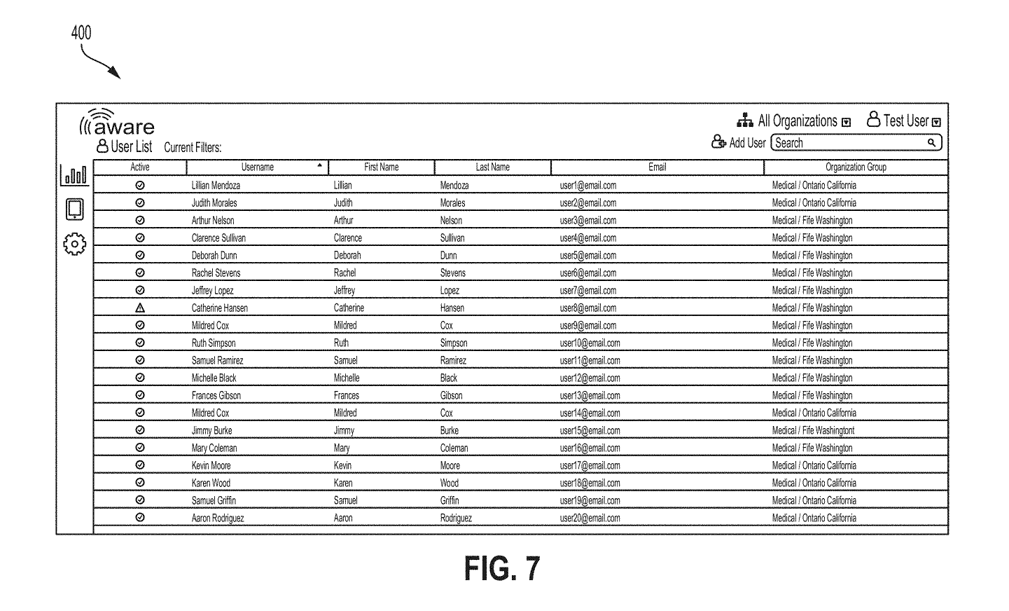

FIGS. 3-7 are diagrams of an example of user interfaces 300, 400 for determining network health based on data from a user device. FIG. 3 is a diagram of an example of the user interface 300 showing information on different organizations groups. In some aspects, assets can be grouped based on any type of organization group. An organization group can include assets connected to a network in a single store. Instead, an organization group can include all the assets connected to a network within a region. In FIG. 3, each of the four organization groups 310, 320, 330, 340 in the system have eighteen active assets but in some aspects, each organization group 310, 320, 330, 340 can have any number of active or total assets. Organization group 310 can be selected. The current response time and average response over the past day, week, and month for organization group 310 can be displayed in response to organization group 310 being selected. Displaying the current response time beside the average response times for an organization group can assist in quickly identifying a problem. The number of reported problems with organization group 310 are grouped and displayed in response to the selection of organization group 310.

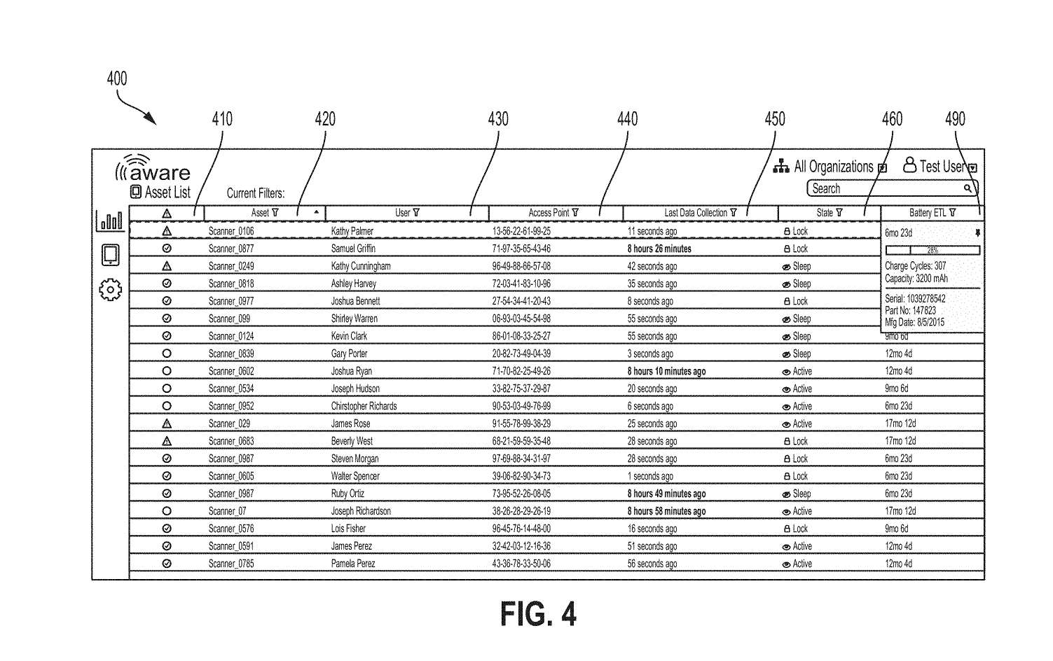

FIGS. 4-7 are diagrams of examples of the user interface 400 depicting records of the data received from different user devices (e.g., different portable scanners that can connect to data networks). The user interface 400 can display data about each user device that has connected to a network. This data can include, for example, data 410 about an activity of the user device, data 420 about an identifier of the user device, data 430 about user associated with the user device, data 440 about an access point to which the user device is connected, data 450 about the last time the user device transmitted data to the system, and data 460 about a state of the user device. In some aspects, the user interface 400 can display information 490 about a battery in the user device and a battery life associated with the battery. In additional or alternative aspects, the user interface 400 can show a performance log 610 and report history 620 for individual user devices or users.

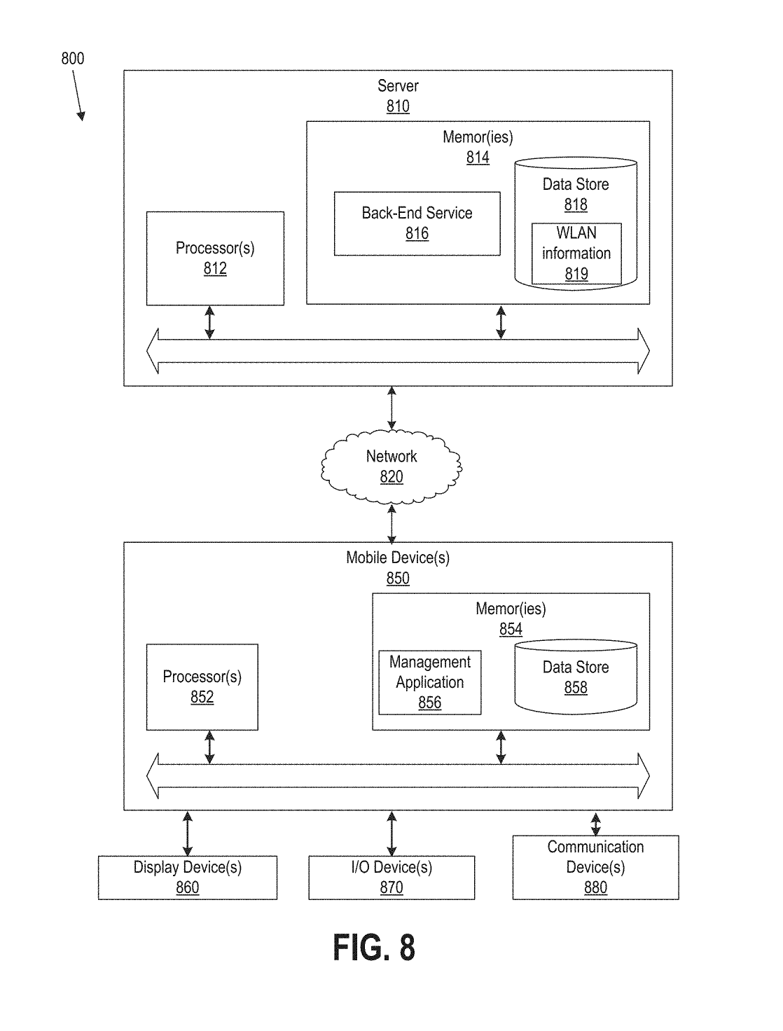

Any suitable device can be used to implement the embodiments described herein. For instance, FIG. 8 is a block diagram depicting examples of computing devices 800 for implementing certain embodiments. The computing devices 800 can include a server 810 and at least one mobile device 850 in communication via a network 820. A general discussion of the components of the server 810 and the mobile device 850 is provided below.

The server 810 may include at least one server computer or any other system providing capabilities for managing access to resources and/or distributing resources to mobile devices. In some embodiments, multiple servers may be employed that are configured in at least one server bank, computer banks, or other arrangements. For example, multiple servers may be configured to provide a cloud computing resource, a grid computing resource, and/or any other distributed computing arrangement. Such servers may be located in a single installation or may be distributed among many different geographic locations. For purposes of convenience, the server 810 is referred to herein in the singular. Even though the server 810 is referred to in the singular, it is understood that multiple servers may be employed in the arrangements as descried herein.

The mobile device 850 can include any suitable computing device or system for communicating via the network and executing at least one application. Non-limiting examples of a mobile device 850 include a laptop computer, a personal digital assistant, a cellular telephone, a set-top box, a music player, a web pad, a tablet computer system, or another device with similar capability. The mobile device 850 may be configured to execute various applications. For example, the mobile device 850 may be configured to execute applications such as web browsing applications, email applications, instant messaging applications, and/or other applications capable of receiving and/or rendering resources on a display associated with the mobile device 850.

The server 810 and the mobile device 850 can include processors 812, 852. Each of the processors 812, 852 may be a microprocessor, an application-specific integrated circuit (“ASIC”), or other suitable processing device. Each of the processors 812, 852 can include any number of computer processing devices, including one. Each of the processors 812, 852 can be communicatively coupled to a computer-readable medium, such as the memory devices 814, 854. Each of the processors 812, 852 can execute computer-executable program instructions and/or accesses information respectively stored in the memory device 814 of the server 810 and in the memory device 854 device of the mobile device 850.

Each of the memory devices 814, 854 can include a computer-readable medium or other memory device. A computer-readable medium or other memory device can include both volatile and nonvolatile memory and data storage components. Volatile components are those that do not retain data values upon loss of power. Nonvolatile components include memory components that retain data upon a loss of power. A computer-readable medium may include (but is not limited to) an electronic, optical, magnetic, or other storage device capable of providing a processor with computer-readable instructions. Other examples comprise, but are not limited to, magnetic disk or other magnetic storage, memory chip, read-only memory (“ROM”), random access memory (“RAM”), an ASIC, a configured processor, optical storage accessed via an optical medium drive, solid-state drives, USB flash drives, memory cards accessed via a memory card reader, magnetic tapes accessed via an appropriate tape drive, and/or other memory components, or a combination of any two or more of these memory components. RAM may include, for example, static random access memory (“SRAM”), dynamic random access memory (“DRAM”), or magnetic random access memory (“MRAM”) and other such devices. ROM may comprise, for example, a programmable read-only memory (“PROM”), an erasable programmable read-only memory (“EPROM”), an electrically erasable programmable read-only memory (“EEPROM”), or other like memory device.

The processor 812 and the memory device 814 of the server 810 may be communicatively coupled to a local interface. The processor and the memory device of the mobile device may be communicatively coupled to a local interface. A local interface can include, for example, a data bus with an accompanying address/control bus or other bus structure. One or more of the processors 812 may represent multiple processing devices and one or more of the memory devices 814 may represent multiple memory devices that operate in parallel processing circuits, respectively. In such a case, one or more of the local interfaces may include an appropriate network that facilitates communication between any two of the multiple processors or between any two of the multiple memory devices. The local interfaces may comprise additional systems designed to coordinate this communication, including, for example, performing load balancing.

The mobile device 850 may also include a number of external or internal devices such as a mouse, a keyboard, a display, audio speakers, one or more microphones, or any other input or output devices 870. For example, the mobile device may include or be in data communication with a display device 860. A non-limiting example of the display device 860 is a computer screen, such as a touch screen. Although FIG. 8 depicts the display device 860 as a separate device coupled to the mobile device 850, the display device 860 can be integrated into the mobile device 850.

The mobile device 850 can also include one or more communication devices 880. One of the communication devices 880 can include a wired network connectivity component such as, for example, an Ethernet network adapter, a modem, and/or the like. The mobile device 850 may further include a wireless network connectivity interface, for example, a Peripheral Component Interconnect (“PCI”) card, a Universal Serial Bus (“USB”) interface, a Personal Computer Memory Card International Association (“PCMCIA”) card, Secure Digital Input-Output (“SDIO”) card, NewCard, Cardbus, a modem, a wireless radio transceiver, a cellular radio, and/or the like. The mobile device 850 may be operable to communicate via wired connection with the server 810 with the aid of the wired network connectivity component. The mobile device 850 may be further operable to communicate wirelessly with the server 810 with the aid of the wireless network connectivity component.

Instructions stored in the memory device 814 of the server 810 and executable by its processor 812 can include a back-end service 816 and/or other applications. The back-end service 816 can include at least one function for controlling resources executed at computing devices such as the mobile device 850, as described in detail herein. Certain data may be stored in a data store 818 of the memory device 814 that is part of or otherwise accessible to the server 810. In some examples the data store 818 can include WLAN information 819 for communicating with the mobile device 850 via the network 820. The illustrated data store 818 may be representative of a multiple data stores, as can be appreciated.

Instructions stored in the memory device 854 of the mobile device 850 and executable by its processor 852 can include a management application 856. The management application 856 can include at least one function for controlling resources executed at computing devices such as mobile device 850, as described in detail herein. Certain data may be stored in a data store 858 of the memory device 854 that is part of or otherwise accessible to the mobile device 850. The illustrated data store 858 may be representative of multiple data stores. The data stored in the data store 858 may be associated with the operation of certain applications and/or functional entities described herein.

As used herein, the term “computer-executable program instructions” is used to refer to a program file that is in a form that can ultimately be run by a processor. Examples of computer-executable program instructions may be, for example, a compiled program that can be translated into machine code in a format that can be loaded into a random access portion of a memory and executed by a processor, source code that may be expressed in proper format such as object code that can be loaded into a random access portion of a memory and executed by a processor, source code that may be interpreted by another executable program to generate instructions in a random access portion of a memory and executed by a processor, and the like. The instructions may comprise processor-specific instructions generated by a compiler and/or an interpreter from code written in any suitable computer-programming language, including, for example, C, C++, C#, Objective-C, PHP, Visual Basic, Java, Python, Perl, JavaScript, and ActionScript. An executable program may be stored in any portion or component of a memory device such as, for example, RAM, ROM, a hard drive, solid-state drive, USB flash drive, memory card, optical disc such as compact disc (“CD”) or digital versatile disc (“DVD”), floppy disk, magnetic tape, or other memory components.

The network 820 facilitates communication between the server 810 and at least one mobile device 850. The network 820 can include any suitable architecture for providing communication channels between the mobile device 850 and the server 810. A communication channel can include any suitable means capable of communicating signals between the mobile device 850 and the server 810. Non-limiting examples of the network 820 include any type of wired network, wireless network, or a combination of wired and wireless networks. A wireless network may be a WLAN, a wireless wide area network (“WIFI”), or any other type of wireless network now known or later developed. Additionally, the network 820 may be or include the Internet, intranets, extranets, microwave networks, satellite communications, cellular systems, personal communication services (“PCS”), infrared communications, global area networks, or other suitable networks, etc., or any combination of two or more such networks.

General Considerations

The foregoing description of the aspects, including illustrated examples, has been presented only for the purpose of illustration and description and is not intended to be exhaustive or limiting to the precise forms disclosed. Many variations and modifications may be made to the above-described examples without departing substantially from the spirit and principles of the disclosure. All such modifications and variations are intended to be included herein within the scope of this disclosure and protected by the following claims.

The flowcharts described herein show certain functionality and operations performed by the management application, client application, proxy service and compliance service, respectively. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor and in a computer system or other system. The machine code may be converted from the source code, etc. If embodied in hardware, each block may represent a circuit or a number of interconnected circuits to implement the specified logical function(s).

Although the flowcharts described herein show a specific order of execution, it is understood that the order of execution may differ from that which is depicted. For example, the order of execution of two or more steps may be scrambled relative to the order shown. Also, two or more blocks shown in succession in the flow charts may be executed concurrently or with partial concurrence. Further, in some embodiments, one or more of the steps shown in the flow charts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Any logic or application described herein that comprises software or code can be embodied in any non-transitory computer-readable medium for use by or in connection with a computing system such as, for example, a processor in a computer system or other system. In this sense, the logic may comprise, for example, statements including instructions and declarations that can be fetched from the computer-readable medium and executed by a computing system.

In the context of the present disclosure, a “computer-readable medium” can include any medium that can contain, store, maintain, or otherwise include the logic or application described herein for use by or in connection with a computing system. The computer-readable medium can comprise any one of many physical media such as, for example, magnetic, optical, or semiconductor media. More specific examples of a suitable computer-readable medium can include, but are not limited to, magnetic tapes, magnetic floppy diskettes, magnetic hard drives, memory cards, solid-state drives, USB flash drives, optical discs, etc. The computer readable medium may be a random access memory (“RAM”). Examples of a RAM can include (but are not limited to) static random access memory (“SRAM”), dynamic random access memory (“DRAM”), magnetic random access memory (“MRAM”), etc. The computer-readable medium may be a read-only memory (“ROM”), a programmable read-only memory (“PROM”), an erasable programmable read-only memory (“EPROM”), an electrically erasable programmable read-only memory (“EEPROM”), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and the following claims.

What is claimed is:

1. A method comprising:
receiving, by a processing device, information about a network from a user device connected to the network;
generating, by the processing device, analytics about a health of the network based on the information; and
providing, by the processing device, instructions for actions to improve the health based on the analytics.

2. The method of claim 1, wherein receiving the information about the network from the user device comprises receiving a response time based on a length of time for the network to respond to the user device.

3. The method of claim 2, wherein the user device comprises a plurality of user devices, wherein generating the analytics about the health of the network comprises:
determining an average response time for the user devices connected to the network;
monitoring a current response time for the user devices connected to the network; and
generating alerts in response to a difference in the average response time and the current response time being above a threshold value.

4. The method of claim 1, wherein receiving the information about the network from the user device comprises receiving a location of the user device or a number of access points detected by the user device.

5. The method of claim 4, wherein providing instructions for actions to improve the health comprises at least one of instructing an access point to increase power, instructing the access point to decrease power, instructing the access point to turn off a channel, instructing a network operator to move the access point, or instructing the user device to move relative to the access point.

6. The method of claim 1, wherein receiving the information about the network from the user device comprises receiving a problem report indicating a problem experienced by the user device and a data log for a period of time associated with the problem.

7. The method of claim 1, wherein receiving the information about the network from the user device comprises:
receiving real-time data from the user device; and
applying a time stamp to the real-time data,
wherein generating the analytics about the health of the network comprises:
determining a connectivity problem between the user device and the network occurred at a particular time; and
analyzing the data having the time stamp within a threshold value of the particular time to determine a solution to the problem.

8. A non-transitory computer-readable medium in which instructions executable by a processing device are stored, wherein executing the instructions causes the processing device to:
receive information about a network from a user device connected to the network;
generate analytics about a health of the network based on the information; and
provide instructions for performing actions to improve the health based on the analytics.

9. The non-transitory computer-readable medium of claim 8, wherein causing the processing device to receive the information about the network from the user device comprises receiving a response time based on a length of time for the network to respond to the user device.

10. The non-transitory computer-readable medium of claim 9, wherein the user device comprises a plurality of user devices, wherein causing the processing device to generate the analytics about the health of the network comprises:
determining an average response time for the user devices connected to the network;
monitoring a current response time for the user devices connected to the network; and
generating alerts in response to a difference in the average response time and the current response time being above a threshold value.

11. The non-transitory computer-readable medium of claim 8, wherein causing the processing device to receive the information about the network from the user device comprises receiving a location of the user device or a number of access points detected by the user device.

12. The non-transitory computer-readable medium of claim 11, wherein causing the processing device to provide instructions for actions to improve the health comprises at least one of instructing an access point to increase power, instructing the access point to decrease power, instructing the access point to turn off a channel, instructing a network operator to move the access point, or instructing the user device to move relative to the access point.

13. The non-transitory computer-readable medium of claim 8, wherein causing the processing device to receive the information about the network from the user device comprises receiving a problem report indicating a problem experienced by the user device and a data log for a period of time associated with the problem.

14. The non-transitory computer-readable medium of claim 8, wherein causing the processing device to receive the information about the network from the user device comprises:
receiving real-time data from the user device; and
applying a time stamp to the real-time data,
wherein causing the processing device to generate the analytics about the health of the network comprises:
determining a connectivity problem between the user device and the network occurred at a particular time; and
analyzing the data having the time stamp within a threshold value of the particular time to determine a solution to the problem.

15. A system comprising:
a processing device; and
a memory device on which instructions are stored,
wherein the processing device is configured to execute the instructions and thereby:
receive information about a network from a user device connected to the network;
generate analytics about a health of the network based on the information; and
provide instructions for performing actions to improve the health based on the analytics.

16. The system of claim 15, wherein causing the processing device to receive the information about the network from the user device comprises receiving a response time based on a length of time for the network to respond to the user device.

17. The system of claim 16, wherein the user device comprises a plurality of user devices, wherein causing the processing device to generate the analytics about the health of the network comprises:
determining an average response time for the user devices connected to the network;
monitoring a current response time for the user devices connected to the network; and
generating alerts in response to a difference in the average response time and the current response time being above a threshold value.

18. The system of claim 15, wherein causing the processing device to receive the information about the network from the user device comprises receiving a location of the user device or a number of access points detected by the user device, wherein causing the processing device to provide instructions for actions to improve the health comprises at least one of instructing an access point to increase power, instructing the access point to decrease power, instructing the access point to turn off a channel, instructing a network operator to move the access point, or instructing the user device to move relative to the access point.

19. The system of claim 15, wherein causing the processing device to receive the information about the network from the user device comprises receiving a problem report indicating a problem experienced by the user device and a data log for a period of time associated with the problem.

20. The system of claim 15, wherein causing the processing device to receive the information about the network from the user device comprises:
receiving real-time data from the user device; and
applying a time stamp to the real-time data,
wherein causing the processing device to generate the analytics about the health of the network comprises:
determining a connectivity problem between the user device and the network occurred at a particular time; and
analyzing the data having the time stamp within a threshold value of the particular time to determine a solution to the problem.
